(19) United States
(12) Patent Application Publication
(10) Pub. No.: US 2003/0200037 A1
(43) Pub. Date: Oct. 23, 2003

(54) Surfboard buoyancy rating and testing apparatus

(76) Inventor: Curtis Courian, San Diego, CA (US)

Correspondence Address: Curtis Charles Courian, 11080 Ipai Ct., San Diego, CA, 92127, US

(21) Appl. No.: 10/127,801

(22) Filed: Apr. 23, 2002

(51) Int. Cl. G06F 19/00

(52) U.S. Cl. 702/55

(57) ABSTRACT

Presently there is very little information or specifications to compare surfboards of similar size. To date no one has thought to measure and mark surfboards with a buoyancy or flotation rating. This invention seeks to improve the chances of a person buying a new surfboard to choose a board most suited to his or her weight and surfing ability. Currently surfboards are marked only with the length, width and thickness. The additional buoyancy rating would be very helpful when choosing or comparing surfboards. The process and testing equipment consist of a tank of water where the board is placed. A strap is attached to the board. A foot lever is used to submerge the board. A scale or force gauge is situated between the board and the lever to record pounds or kilogram of weight required to submerge the board. A permanent marking of the buoyancy recorded is fixed to the board.

### CROSS-REFERENCE TO RELATED APPLICATIONS

No known related applications

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

This application applies to sporting watercraft and specifically to surfboards, wind surfing boards and body boards. (US patent Classification 441/74)

The modern surfboard design and construction has not changed much in the last 40 years. The basic process is the same. A closed cell rigid foam “blank” (a semi formed block of foam) is ground or “planed” to the desired shape and size. The blank is finish sanded. Fibreglass or a reinforcing cloth is coated with polyester or epoxy resin and allowed to cure. The board is sanded and fins attached. A hard skinned smooth surfboard is the result.

This hand made one of a kind manufacturing process is rare in this day and age. CAD and CNC router machines have been introduced to the rough shaping process and have helped the speed and consistency of the shaping process. Unfortunately several hand done steps still remain the same.

One thing unique to surfing is the quest for the “magic” or perfect board. There can be a significant different in the performance of similar boards. The average surfer will buy numerous boards during his or her career. At US $400- $1500 this will add up to a substantial investment.

At present boards are shaped using a number of templates and the keen eye of the shaper. Usually the outline of the perimeter, the bottom “rocker” or curve, the length, width and thickness are the primary dimensions that identify each board. The length, width, tail width and thickness are usually written on the board to identify to a purchaser what he or she is buying. These are the only specifications that are known that separate one surfboard from another.

The present dimensional way of ranking each board is the way it has always been done. There is clearly a void of information when it comes to selecting a surfboard off a rack of 20 or 30 boards of similar length, width and thickness.

Ask any surfer if he ever had two boards ride the same and the answer will be no. Given the exact same specifications, the boards will not ride the same. There are just too many tiny differences when a product is manufactured by hand.

One factor, presently ignored, that impacts greatly the performance of a surfboard is buoyancy or flotation. Buoyancy in a surfboard helps the board to plane over the water quicker and ultimately creates more speed. Taking a bit more foam off during shaping and maybe a slightly thicker fibreglass coating could make one board less buoyant than the seemingly exact same board.

I believe a buoyancy rating or factor of a surfboard, once standardized, would give the surfboard buyer a big advantage. He would be able to compare a new board's buoyancy to boards that he/she has already ridden and avoid buying a board with less or more flotation than he thinks is necessary. Weight gain of the surfer might require a higher flotation rating. A younger more skilled rider might want to move to a board with a little less volume/buoyancy to perform more radical manoeuvres. There is clearly a need for additional data identifying a surfboard.

### BRIEF SUMMARY OF THE INVENTION

The invention is simply the process of identifying accurately the flotation or buoyancy of a surfboard and permanently marking it for comparison purposes. This would require a piece of testing equipment that could turn out a practical as well as an accurate rating for each board. Standardising of the buoyancy would classify all boards. Putting together the present dimensional information and the new buoyancy calculation would make it much easier to zero in on the next choice for a new surfboard. Avid surfers and professionals who go through 100's of boards (and have on hand dozens) would find it much easier to select their equipment and possibly be able to tailer their board choice to the specific conditions in the surf.

### BRIEF DESCRIPTION OF THE SEVERAL VIEWS OF THE DRAWING

FIG. 1A::(1) A tank with a length, width and depth large enough to fit and submerge a full range of typical surfboards. (2) Recesses provided for fins and watertight transition. (3) The tank would be supported by legs designed to hold the weight of the water and the surfboard. (4) A means of attaching to the board in order to submerge it, preferably a strap or sling with little weight of it's own. (5) A watertight transition through the tank. (6) A force gauge to measure the pounds of weight to submerge the surfboard. (7) A foot lever with an outboard fulcrum attached to the force gauge sufficiently long to overcome the buoyancy of the surfboard. (8) A locking strut to hold the lever in the submerge position in order for the operator to read the force gauge.

FIG. 2A:: Testing equipment in the submerge position

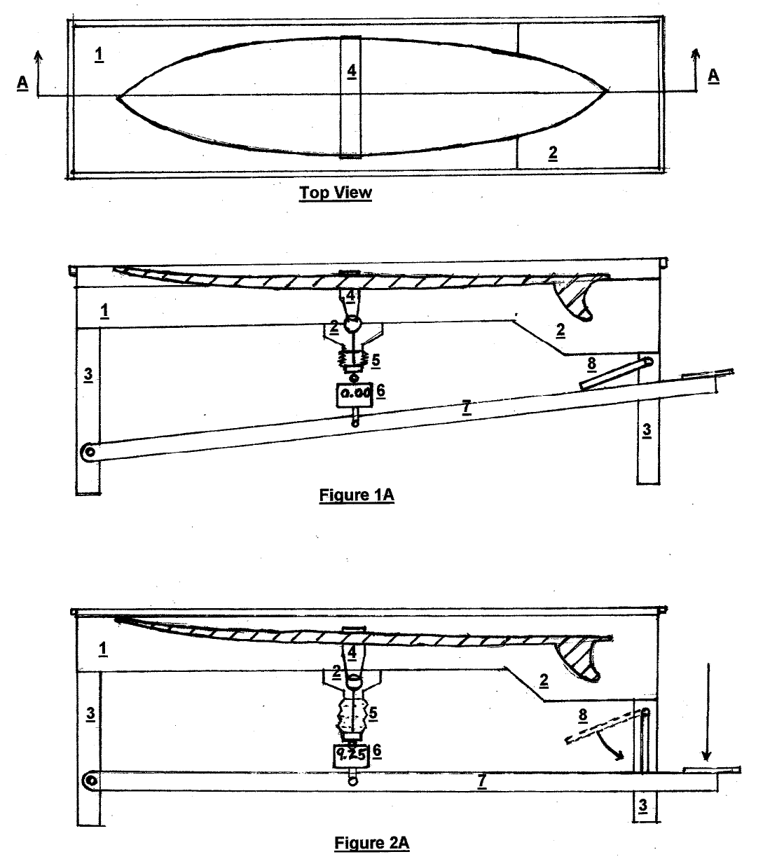

### DETAILED DESCRIPTION OF THE INVENTION

The Process: Each surfboard manufactured would be tested for buoyancy in the testing tank. A “pounds or like measure of force to submerge the board” would be recorded. A proprietary sticker, etching or other permanent means would be used to apply the buoyancy rating number to the board.

This process is completely new and novel. With no other prior art noted. Boards with buoyancy rating numbers would have more value because they would be able to be compared to other such boards.

The new buoyancy rating standard etched into each board would be in addition to the dimensional information presently applied to each board.

The process must include submerging the surfboard. There are other means of making a basic calculation of flotation (volume, density, weight, mass etc.) but submerging the board is closest to how the board is used in the water. The pounds or kg to submerge an object also is affected by the materials and density. Other ways of calculating the flotation would not take into account the specific materials of each board, the fins, fibreglass thickness or blank material (remember all boards are slightly different). Submerging would combine all of the characteristics of the board and translate it into a single number (simple).

The Invention:: In order for standardising of the buoyancy rating the testing equipment must be constructed in a like manner. The preferred embodiment is as follows.

(1) A waterproof tank large enough in length, width and depth to accept a full range of surfboard sizes. A tank strong enough to hold the weight of the water. Many materials would be acceptable; aluminium would be preferred because of the strength to weight ratio.

(2) Tank supports attached to the tank. Legs or similar means to elevate the tank to a comfortable working level and to allow room for the force gauge (5) and the foot lever (6) underneath. Tank supports spaced to distribute the water weight. Aluminium welded construction preferred.

(3) Sling. A strap or sling to hold the surfboard while the force to submerge it is being applied. Nylon strapping with a buckle, Velcro or other means of opening and closing the loop to attach each board. On the underside of the strap a transition to a single strap for coupling to the waterproof transition (4) would be required. The sling needs to be as light in weight as possible in order not to add any significant weight to the surfboard.

(4) Waterproof transition located near the center of the tank. To prevent leaking, a waterproof transition between the sling (3) and the force gauge (5) must be used. A rubber bellows would be the preferred means (note: a number of transitions would work). Most importantly the transition must not create friction which would give the force gauge a false reading.

(5) The force gauge is connected to the sling at the waterproof transition. Any number of commercially available force gauges would be acceptable. A force gauge is essentially a weight scale that is activated by either pushing or pulling on the meter ends. A digital gauge measuring to the hundredth place is preferred.

(6) A foot lever is attached to the tank legs (2) creating an outboard fulcrum that is long enough to extend to the end of the tank and able to have enough leverage to submerge the surfboard. The lever would attach to the force gauge (5) in line with the waterproof transition (4). A ring and hook, nylon strapping, chain or any other flexible connection would connect the lever and force gauge.

(7) A locking strut is provided to hold the board in the submerged position. A shaft, rod or post connected to the leg frame (2) directly above the foot lever (6) could be placed on the foot petal to hold it down giving the operator a chance to read the force gauge (5)

What I claim is:

1. A process of submerging a surfboard in water by pulling or pushing it under with a force gauge or weight scale connected to it, generating a reading, and permanently recording it or the surfboard, for the purpose of comparing the buoyancy characteristics of one surfboard to another.

2. The process recited in claim 1, to include, the process of measuring in any way the volume, density, flotation, or buoyancy of a surfboard, wind surfing board or body board, for the purpose of classifying or comparing them.

3. A piece of testing equipment comprising a water tank, a means for submerging a surfboard in said tank, a force gauge or weight scale to record the force required to submerge the surfboard and a waterproof connection from the surfboard to the force gauge or weight scale.

4. A piece of testing equipment recited in claim 3, wherein nylon or similar strapping of any width is used to hold the surfboard under water while connected to the force gauge or weight scale.

5. A piece of testing equipment recited in claim 4, wherein a flexible, low or no friction, waterproof transition method is used to connect the nylon strapping holding the surfboard to the force gauge or weight scale preventing leakage from the water tank and allowing movement to 1 submerge the surfboard.
